(19) United States
(12) Patent Application Publication
(10) Pub. No.: US 2020/0276975 A1
(43) Pub. Date: Sep. 3, 2020

(54) TRACTION CONTROLLER FOR A MOTOR VEHICLE

(71) Applicant: ZF Active Safety GmbH, Koblenz (DE)

(72) Inventors: Andreas Passmann, Hilgert (DE); Christian Hachenberg, Güllesheim (DE)

(73) Assignee: ZF Active Safety GmbH, Koblenz (DE)

(21) Appl. No.: 16/650,222

(22) PCT Filed: Aug. 8, 2018
(86) PCT No.: PCT/EP2018/071467

§ 371 Date: Mar. 24, 2020

(30) Foreign Application Priority Data
Sep. 25, 2017 (DE) 10 2017 008 949.3

(51) Int. Cl. B60W 30/18; B60W 10/18; G01S 19/42

(52) U.S. Cl. CPC B60W 30/18172; B60W 10/18; G01S 19/42; B60W 2520/28; B60W 2720/263; B60W 2520/26; B60W 2420/42; B60W 2420/52; B60W 2520/10

(57) ABSTRACT

A device for wheel slip control on a motor vehicle having at least one front axle and at least one rear axle is specified, wherein the front axle is assigned at least one front actuator for influencing at least one linear front wheel speed, and the rear axle is assigned at least one rear actuator for influencing at least one linear rear wheel speed. The device comprises at least one interface, which is designed to receive the following parameters: at least one first parameter indicating the at least one linear front wheel speed; at least one second parameter indicating the at least one linear rear wheel speed; and at least one third parameter indicating a vehicle speed, wherein the at least one third parameter is different from the at least one first parameter and the at least one second parameter.

### CROSS-REFERENCE TO RELATED APPLICATION

This application is a national stage of International Application No. PCT/EP2018/071467, filed Aug. 8, 2018, the disclosure of which is incorporated herein by reference in its entirety, and which claimed priority to German Patent Application No. 102017008949.3, filed Sep. 25, 2017, the disclosure of which is incorporated herein by reference in its entirety.

### TECHNICAL FIELD

In general terms, the present disclosure relates to the field of motor vehicle engineering. More specifically, aspects are described in the context of a wheel slip controller.

### BACKGROUND

All modern vehicles are equipped with systems for wheel slip control. In known control systems, such as an antilock, traction control or electronic stability control system, the slip of a vehicle wheel is controlled by comparing the linear wheel speed of the relevant wheel with the vehicle speed as a reference. Depending on a result of the comparison, the actual slip control is then performed by alternately decelerating and accelerating the relevant wheel.

Generally speaking, components of a vehicle brake system are used as actuating units, also referred to as actuators, for slip control. Thus, in the case of a hydraulic brake system, the actuators are based on an electronically controlled hydraulic unit having a pump for generating brake pressure and having control valves for modulating the brake pressure in the wheel brakes by setting pressure buildup, pressure reduction and pressure holding phases.

In a conventional slip control system, the slip s_{RAD} of a wheel, which is obtained from the linear wheel speed v_{RAD} of the relevant wheel and from the vehicle speed v_{REF} in accordance with the formula

s_{RAD}=|v_{REF}−v_{RAD}|/v_{REF},

is controlled discretely in relation to a particular slip threshold s_{STABIL}.

This control strategy is illustrated for a hydraulic brake system in FIG. 1. For as long as the wheel slip s_{RAD} for a particular wheel is in the stable range, i.e. as long as 0<=s_{RAD}<s_{STABIL}, the relevant wheel is decelerated on the basis of the prevailing wheel brake pressure. Once the unstable range is reached at s_{RAD}>=s_{STABIL}, the relevant wheel is accelerated again by a brake pressure buildup. This acceleration phase continues until the linear wheel speed v_{RAD} of the relevant wheel once again corresponds to the vehicle speed v_{REF}, i.e. there is then (almost) no wheel slip (s_{RAD}=0). The resulting maxima in the characteristic of the linear wheel speed v_{RAD} (cf. FIG. 1) are evaluated to enable the current (changed) vehicle speed v_{REF} to be determined on that basis. When a maximum in the characteristic of the linear wheel speed v_{RAD} is reached, the relevant wheel is then decelerated again.

In the case of the wheel slip control outlined above, it has been found that an unnecessarily long braking distance is the result in many cases. Although there are alternative wheel slip control strategies, these are associated with other disadvantages.

### SUMMARY

It is the underlying object of the present disclosure to specify an efficient wheel slip controller.

According to a first aspect, a device for wheel slip control on a motor vehicle having at least one front axle and at least one rear axle is specified, wherein the front axle is assigned at least one front actuator for influencing at least one linear front wheel speed, and the rear axle is assigned at least one rear actuator for influencing at least one linear rear wheel speed. The device comprises at least one interface, which is designed to receive the following parameters: at least one first parameter indicating the at least one linear front wheel speed; at least one second parameter indicating the at least one linear rear wheel speed; and at least one third parameter indicating a vehicle speed, wherein the at least one third parameter is different from the at least one first parameter and the at least one second parameter. The device furthermore comprises a processor unit, which is communicatively coupled to the at least one interface and is designed to determine at least one front wheel slip and at least one rear wheel slip on the basis of the at least one first parameter, the at least one second parameter and the at least one third parameter. The processor unit is furthermore designed to generate control signals for the at least one rear actuator and/or the at least one front actuator as a function of the at least one front wheel slip and the at least one rear wheel slip, in accordance with a target slip which is different from zero.

The wheel slip control presented here can be performed in the context of an antilock brake system (ABS), a traction control system (TCS) and/or an electronic stability control system (also referred to as an electronic stability program, ESP, or vehicle stability control, VSC), for example. Thus, the wheel slip controller presented here can be implemented in one or more of these control approaches.

The front axle can be assigned one wheel or more than one wheel. The same applies to the rear axle. In this context, the wheel slip control can be performed at individual wheels. Thus, for example, wheel slip control may be performed only at that wheel or those wheels at which slip has been detected (the reaching or exceeding of a slip threshold can be used for slip detection in this context). In this case, slip control takes place for the at least one front wheel and for the at least one rear wheel based on a target slip which is different from zero. It is self-evident that this target slip control for the at least one front wheel and for the at least one rear wheel can take place at the same point in time or at different points in time, depending on the slip detected at each individual wheel. In this process, a linear wheel speed which differs continuously from the vehicle speed may be established at the wheel subject to target slip control. In particular, the linear wheel speed may be continuously higher than the vehicle speed.

The target slip may be substantially constant with respect to time. In this case, the term constant slip control is also used.

The at least one first parameter and the at least one second parameter can be based on a first measured variable in respect of the respective wheel (e.g. the respective angular wheel speed). The at least one third parameter can be based on at least one second measured variable different from the first measured variable. Thus the at least one third parameter may be based on the two second measured variables of time and vehicle position (which allow the vehicle speed to be inferred). The vehicle position can be determined in a satellite-based, camera-based or radar-based way or in some other way. It is not necessary here to determine the absolute position of the vehicle. On the contrary, it is sufficient to evaluate changes in the relative position of the vehicle as a function of time.

The at least one third parameter can specify the vehicle speed directly (e.g. in units of [m/s] or [km/h]). As an alternative, the at least one third parameter enables the vehicle speed to be determined (e.g. by specifying position information on the vehicle at known points in time).

The at least one interface can be a physical interface (e.g. one implemented with electric contacts) and/or a logical interface (e.g. one implemented by means of software). It is also conceivable for the at least one interface to be implemented in the form of several logical interfaces (e.g. one logical interface per parameter), to which the same physical interface is assigned (e.g. the same electric contacts).

In one variant, the at least one interface is designed to receive one or more of said parameters in the form of a respective digital signal. The at least one interface can be designed as a vehicle bus interface (e.g. in accordance with the control area network, CAN, or local interconnect network, LIN, standard).

According to a first embodiment, the at least one interface can be coupled or is coupled to a satellite-based position determination system. The position determination system is designed to generate the at least one third parameter or a variable on which the at least one third parameter is based. For example, the device can receive the at least one third parameter in the form of position information at known points in time. This then enables the processor unit to determine the vehicle speed. Indirect coupling of the at least one interface to the satellite-based position determination system is also conceivable. In this case, a unit arranged between the position determination system and the at least one interface can determine the at least one third parameter from the position information supplied by the position determination system.

According to a second embodiment, which can be combined with the first embodiment, the at least one interface can be coupled or is coupled to a radar-based system, which is designed to generate the third parameter or a variable on which the third parameter is based. The radar-based system can be part of an “adaptive cruise control” (ACC), which normally maintains a predetermined distance from a vehicle in front. The device can be designed to determine the vehicle speed from the information received from the radar-based system. According to the second embodiment too, indirect coupling of the at least one interface to the radar-based system is also conceivable. In this case, a unit arranged between the radar-based system and the at least one interface can determine the at least one third parameter from the information supplied by the radar-based system.

According to a third embodiment, which can be combined with the first and/or second embodiment, the at least one interface can be coupled or is coupled to a camera-based system, which is designed to generate the third parameter or a variable on which the third parameter is based. The device can be designed to determine the vehicle speed from the information (in particular image or video information) received from the camera-based system. According to the third embodiment too, indirect coupling of the at least one interface to the camera-based system is also conceivable. In this case, a unit arranged between the camera-based system and the at least one interface can determine the at least one third parameter from the information supplied by the camera-based system.

The abovementioned three embodiments can be combined. Thus, for example, the information supplied by the second and/or third embodiment can be used to check the plausibility of the information supplied by the first embodiment or vice versa.

The at least one interface can be designed to receive both the at least one first parameter and the at least one second parameter in the form of angular wheel speed signals or of linear wheel speeds derived from the angular wheel speed signals. In the first case, the processor unit can calculate the linear wheel speeds from the angular wheel speeds.

The processor unit can be designed to determine a fourth parameter indicating the corresponding slip for a particular wheel by comparing the corresponding linear wheel speed with the vehicle speed. For this purpose, it is possible, in particular, for the processor unit to be designed to determine the fourth parameter for the particular wheel as follows:

s_{RAD}=|v_{REF}−v_{RAD}|/v_{REF},

wherein s_{RAD} is the fourth parameter, v_{RAD} is the linear wheel speed and v_{REF} is the vehicle speed. The control signals for the at least one actuator assigned to the particular wheel can then be determined to the effect that the fourth parameter is regulated toward a target slip different from zero.

In general, the control signals for the at least one actuator assigned to the particular wheel can be determined to the effect that the particular wheel is alternately decelerated and accelerated. Various actuators assigned to the wheel or various functional units of a single actuator assigned to the wheel can be used for the deceleration and acceleration of the particular wheel.

The device can be designed as a control unit (e.g. as an electronic control unit, ECU). The device can also comprise a plurality of such control units, which are or can be communicatively coupled to one another.

According to a second aspect, a vehicle brake system is specified. The brake system comprises the device presented here, the at least one front actuator and the at least one rear actuator. The at least one front actuator and the at least one rear actuator can each comprise a wheel brake, e.g. a wheel brake which can be actuated hydraulically and/or mechanically and/or regeneratively (with an electric generator effect). Thus, the at least one front actuator can comprise a front wheel brake, and the at least one rear actuator can comprise a rear wheel brake.

A third aspect relates to a method for wheel slip control on a motor vehicle having at least one front axle and at least one rear axle, wherein the front axle is assigned at least one front actuator for influencing at least one linear front wheel speed, and the rear axle is assigned at least one rear actuator for influencing at least one linear rear wheel speed. The method comprises receiving at least one first parameter indicating the at least one linear front wheel speed, receiving at least one second parameter indicating the at least one linear rear wheel speed and receiving at least one third parameter indicating a vehicle speed, wherein the at least one third parameter is different from the at least one first parameter and the at least one second parameter. The method furthermore comprises determining at least one front wheel slip and at least one rear wheel slip on the basis of the at least one first parameter, the at least one second parameter and the at least one third parameter, and generating control signals for the at least one rear actuator and/or the at least one front actuator as a function of the at least one front wheel slip and the at least one rear wheel slip, in accordance with a target slip which is different from zero.

Also specified is a computer program product comprising program code means for carrying out the method presented here when the latter is carried out on a processor unit. Also specified is a control unit or system comprising a plurality of control units with the computer program product. The computer program product can therefore be distributed between a plurality of control units, which can be coupled communicatively to one another.

### BRIEF DESCRIPTION OF THE DRAWINGS

Further aspects, details and advantages of the present disclosure will become apparent from the following description of illustrative embodiments and the figures, of which:

FIG. 1 shows a schematic illustration of a conventional slip controller on a vehicle wheel;

FIG. 2 shows a block diagram of one illustrative embodiment of a device for wheel slip control;

FIG. 3 shows a block diagram of one illustrative embodiment of a brake system with wheel slip control functionality;

FIG. 4 shows a flow diagram of one illustrative embodiment of a method for wheel slip control; and

FIG. 5 shows a schematic illustration of a target slip control process of the kind used on the front wheels and rear wheels respectively.

### DETAILED DESCRIPTION

According to the illustrative embodiments explained below, a target slip control process (also referred to as constant slip control) is used both on the wheel (or wheels) of the front axle and on the wheel (or wheels) of the rear axle, during which the system regulates toward a target slip different from zero.

In an illustrative target slip control strategy, a particular target slip, which represents a stability limit value, is used as a reference variable (also referred to as a setpoint), and the linear wheel speed of the relevant wheel is used as the controlled variable. Here, target slip control is distinguished from conventional slip control in that the linear wheel speed of the relevant wheel has a characteristic with little fluctuation. This gives rise to several advantages. Thus, a linear wheel speed characteristic with little fluctuation allows more efficient exploitation of the friction coefficient of the roadway than conventional slip control, and therefore short braking distances are achieved. Moreover, the linear wheel speed characteristic with little fluctuation results in almost constant progress of the deceleration and acceleration phases to be set by the actuator concerned, with the result that less actuating noise occurs and less actuating energy is consumed during operation.

By virtue of the control concept of target slip control (with a target slip different from zero), the linear wheel speed of the controlled wheel never reaches the vehicle speed, and the controlled wheel is never in a slip-free state (s_{RAD}=0). However, it is precisely these maxima in the characteristic of the linear wheel speed that are required in conventional slip control to enable the vehicle speed to be determined on the basis of the linear wheel speed. In general, it is only possible to determine the vehicle speed as a function of the linear wheel speed of at least one slip-free vehicle wheel (while other influences, e.g. cornering, also have to be taken into account).

To enable the vehicle speed to be determined as accurately as possible, the linear wheel speeds of at least two slip-free vehicle wheels are ideally used, e.g. the wheels on the rear vehicle axle. For the purpose of exploiting the dynamic axle load distribution during the braking process, it would therefore be possible to provide regulation to a target slip different from zero only for the wheels on the front vehicle axle, while implementing conventional slip control only for the wheels on the rear vehicle axle for the purpose of determining the vehicle speed. According to the following illustrative embodiments, however, in order to achieve a further improvement in braking performance in respect of the braking distance, target slip control is implemented for the wheels on all vehicle axles, and the wheel slip control system is supplied with the vehicle speed by one or more other vehicle systems in parallel with the angular wheel speeds, e.g. via communication systems, such as the CAN bus, which are present in the vehicle in any case.

A different vehicle system of this kind can be an ACC (adaptive cruise control) system, for example, which comprises radar- and/or camera-based sensors which can determine the vehicle speed as a reference in real time. Moreover, the vehicle speed could be communicated by a vehicle navigation system which receives satellite-based information, e.g. GPS data, and can determine the ground speed of the vehicle.

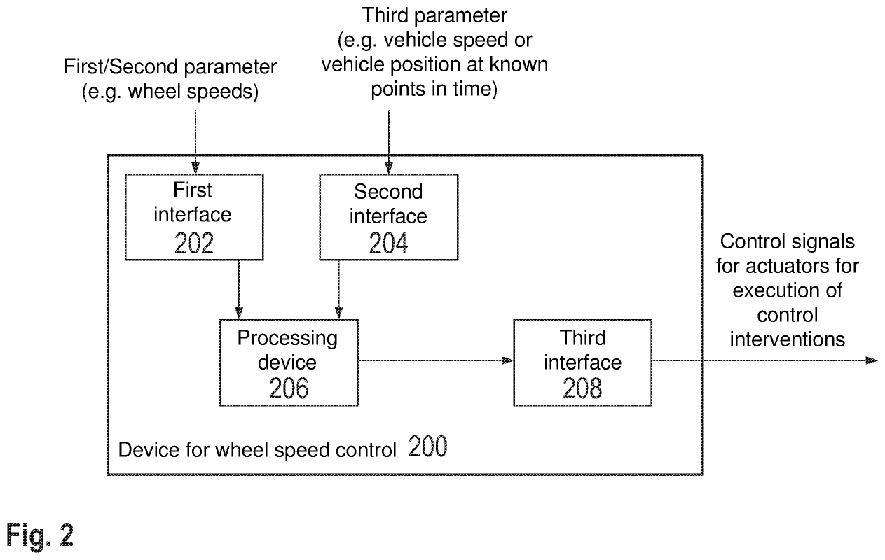

FIG. 2 shows an illustrative embodiment of a device 200 for target slip control on a motor vehicle having at least one front axle and at least one rear axle. Here, the front axle is assigned at least one front actuator for influencing at least one linear front wheel speed, and the rear axle is assigned at least one rear actuator for influencing at least one linear rear wheel speed. The actuators, which are not illustrated in FIG. 2, can be components of a vehicle brake system.

Thus, in the case of a hydraulic brake system, an illustrative actuator comprises electronically controlled hydraulic components such as a pump for generating brake pressure and control valves for modulating the brake pressure in the wheel brakes by setting pressure buildup, pressure reduction and pressure holding phases. In the case of an electromechanical brake system, an actuator comprises an electric motor provided for the actuation of a wheel brake or of a braking force generator. In the case of a regenerative brake system, the electric drive unit of an electric or hybrid vehicle can be operated alternately as a generator or a motor in order to serve as an actuator component in the context of wheel slip control. Of course, it is also possible for the actuators present in a combined brake system, e.g. a hydraulic brake system combined with a regenerative braking functionality, to be used jointly for wheel slip control.

As illustrated in FIG. 2, the device 200 comprises at least one first interface 202, which is designed to receive at least one first parameter indicating the at least one linear front wheel speed and at least one second parameter indicating the at least one linear rear wheel speed. In general, in the case of n front wheels, n first parameters can be received and, in the case of m rear wheels, m second parameters can be received, where n, m=1, 2, 3, etc.

The device 200 furthermore comprises at least one second interface 204, which is designed to receive at least one third parameter indicating a vehicle speed, wherein the at least one third parameter is different from the at least one first parameter and the at least one second parameter.

Moreover, the device comprises a processor unit 206, which is communicatively coupled to the at least one first interface 202 and to the at least one second interface 204. The processor unit 206 is designed to determine at least one front wheel slip and at least one rear wheel slip on the basis of the at least one first parameter, the at least one second parameter and the at least one third parameter. The processor unit 206 is furthermore designed to generate control signals for the at least one rear actuator and/or the at least one front actuator as a function of the at least one front wheel slip and the at least one rear wheel slip, in each case on the basis of target slip control with a target slip which is different from zero, in particular constant slip control.

As shown in FIG. 2, the device 200 furthermore comprises at least one third interface 208 for feeding the control signals to the respective actuator.

The interfaces 202, 204, 208 mentioned can each be an interface implemented by programming. In one variant, such logical interfaces are mapped onto a single physical vehicle bus interface of the device 200. In another variant, the two logical interfaces 202, 204 are mapped onto a first physical vehicle bus interface, while the third interface 208 is mapped onto a second physical vehicle bus interface.

A separate first logical interface 202 can be provided for each wheel. In the same way, a separate third logical interface 208 can be provided for each actuator. The number of second logical interfaces 204 can correspond to the number of third parameters, which each indicate the vehicle speed independently of one another (e.g. for purposes of plausibility checking).

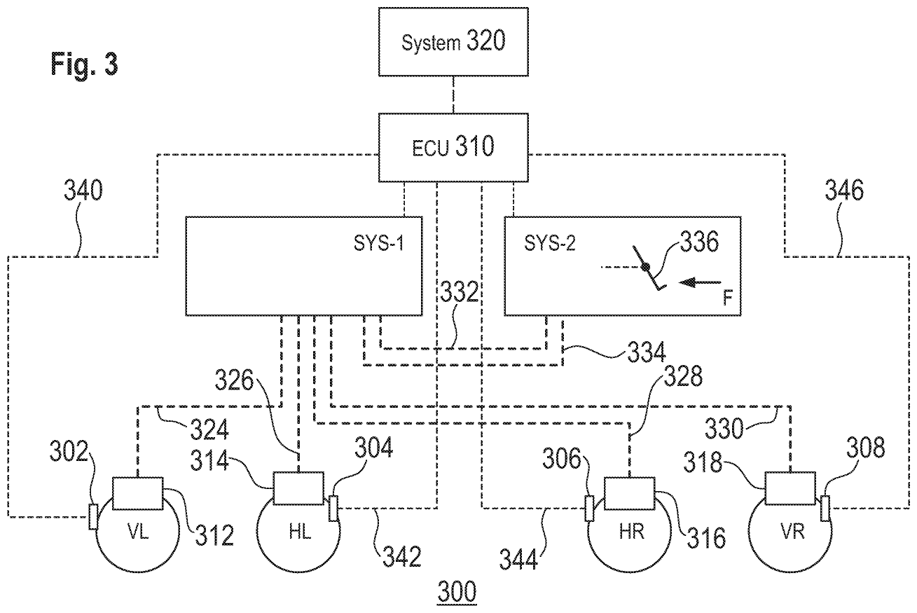

An illustrative embodiment of a motor vehicle brake system 300 with target slip control functionality is illustrated schematically in FIG. 3. In the illustrative embodiment, the device 200 described in connection with FIG. 2 is integrated into the brake system 300.

The brake system 300 is designed to decelerate each of four wheels of the motor vehicle by generating a braking force at the respective wheel or to accelerate the wheel by reducing the braking force currently prevailing at the wheel. The four wheels are split into opposite pairs on two axles, namely a front axle and a rear axle. In FIG. 3, the left-hand front wheel is denoted by VL and the left-hand rear wheel is denoted by HL, while HR denotes the right-hand rear wheel and HL denotes the left-hand rear wheel. Each of the four wheels VL, HL, HR and HL is assigned a separate angular wheel speed sensor 302, 304, 306 and 308, respectively. The speed of the respective wheel VL, HL, HR and HL can be determined in a known manner from the signals of the angular wheel speed sensors 302, 304, 306 and 308.

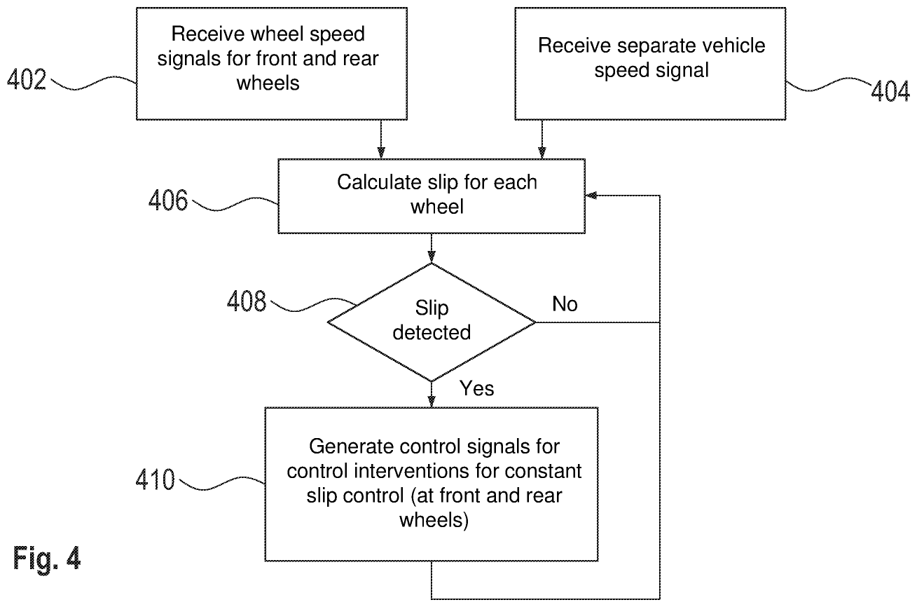

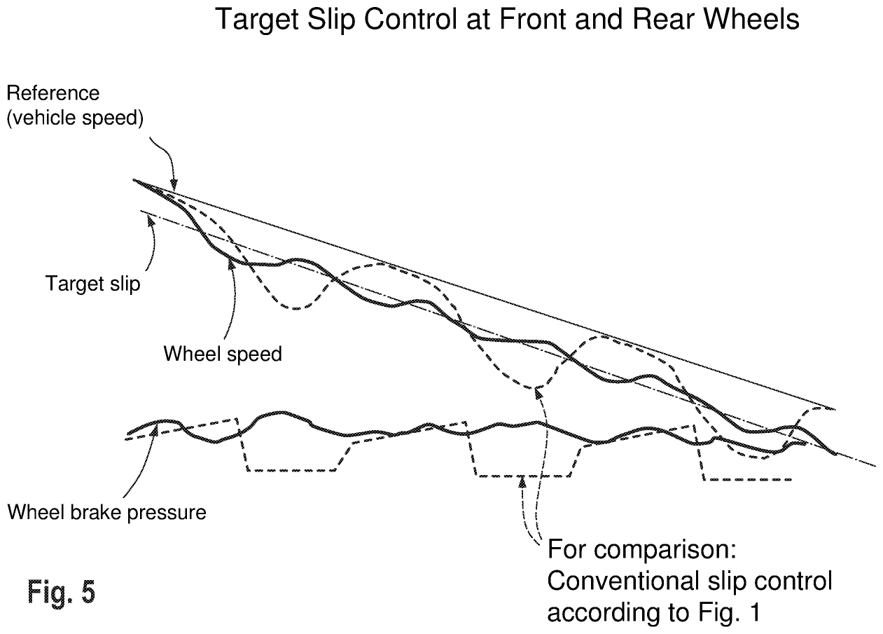

The motor vehicle brake system 300 comprises at least one electronic control unit 310 (also referred to as an electronic control unit, ECU) and four wheel brakes 312, 314, 316, 318, which are hydraulically actuable in the illustrative embodiment. In general terms, the control unit 310 has the structure illustrated in FIG. 2 and is designed to carry out the functions explained below with reference to FIG. 4 and FIG. 5.

In the illustrative embodiment under consideration, the control unit 310 is communicatively coupled to the angular wheel speed sensors 302, 304, 306 and 308 via the first interface 202 shown in FIG. 2 to enable the linear wheel speeds of the four wheels VL, HL, HR and HL to be determined. For this purpose, an analog or digital signal line 340, 342, 344 and 346 leads from each of the angular wheel speed sensors 302, 304, 306 and 308 to the first interface 202 of the control unit 310. In an alternative illustrative embodiment, the angular wheel speed sensors 302, 304, 306 and 308 could be coupled to a further control unit (not illustrated in FIG. 3), which determines the linear wheel speeds and then supplies them to the control unit 310 in the form of analog or digital signals (namely via the first interface 202 thereof, as per FIG. 2).

The brake system 300 furthermore comprises a first actuating system SYS-1 and a second actuating system SYS-2. The two actuating systems SYS-1 and SYS-2 are designed to be able to generate a braking force independently of one another at at least a subset of the four wheel brakes 312, 314, 316, 318.

The four wheel brakes 312, 314, 316, 318 each comprise a brake disk and two brake pad holders (not illustrated) interacting with the brake disk and actuable by a wheel brake cylinder. A replaceable brake pad (likewise not illustrated) is mounted on each brake pad holder. Each of the four wheel brakes 312, 314, 316, 318 can be designed as a fixed or floating caliper brake, for example.

Furthermore, the brake system 300 comprises a system 320 for determining the vehicle speed. The system 320 is designed to determine the vehicle speed (or a parameter indicating the latter) without recourse to the signals supplied by the angular wheel speed sensors 302, 304, 306 and 308. Thus, the system 320 can be a satellite-based system, a camera-based system or a radar-based system. It is also possible for two or more such systems 320 to be provided for mutual plausibility checking. The system 320 is communicatively coupled to the control unit 310 via the second interface 204 illustrated in FIG. 2.

In the illustrative embodiment illustrated in FIG. 3, the control unit 310 allows control at least of the actuating system SYS-1 for target slip control on the basis of control signals generated by the control unit. These control signals are generated on the basis of an evaluation of the linear wheel speeds (which have been determined by the control unit 310 or by some other means on the basis of the signals of the angular wheel speed sensors 302, 304, 306, 308) and an evaluation of the vehicle speed (which has been determined by the control unit 310 or by some other means on the basis of the signals of the system 320). The corresponding control and evaluation tasks can also be distributed between two or more separate control units 310.

Each of the wheel brakes 312, 314, 316 and 318 is connected to the first actuating system SYS-1, to be more precise to a hydraulic control unit (HCU, not illustrated in FIG. 3) thereof, via a respective hydraulic line 324, 326, 328 and 330. In the present case, the first actuating system SYS-1 is a system which allows individual generation, reduction and control of the brake pressures in the wheel brakes 312, 314, 316, 318 independently of the driver. Brake pressure control can take place, in particular, in the context of the target slip control presented here, e.g. for a TCS, ABS or ESP control intervention. For this purpose, the first actuating system SYS-1 comprises, in a known manner, a plurality of hydraulic valves and at least one electrically actuable hydraulic pressure generator (e.g. a multi-piston pump). These components are controlled by the control signals, which are generated by the control unit 310, for the purpose of slip control at one or more of the four wheels VL, VR, HL and HR.

The second actuating system SYS-2 is connected to the first actuating system SYS-1 via hydraulic lines 332, 334 and is designed to generate brake pressures for the first actuating system SYS-1 and/or the wheel brakes 312, 314, 316, 318. To generate hydraulic pressure, the second actuating system SYS-2 can comprise a master cylinder actuable by means of a brake pedal 336 and/or an electrically actuable hydraulic pressure source (for brake boosting or as part of a brake-by-wire, BBW, system).

FIG. 4 illustrates an illustrative embodiment of a method for target slip control at all four wheels VL, VR, HL and HR in a flow diagram 400. The method shown in FIG. 4 is explained below with reference to the device shown in FIG. 2 and the brake system 300 shown in FIG. 3.

In steps 402 and 404, the device 200 continuously receives a plurality of parameters via the interfaces 202 and 204. These parameters are the angular wheel speeds (or the linear wheel speeds derived therefrom) measured by the angular wheel speed sensors 302, 304, 306 and 308 and a vehicle speed determined by the system 320 (which is precisely not or not principally based on the angular wheel speeds measured by the angular wheel speed sensors 302, 304, 306 and 308). Steps 402 and 404 can be carried out in any order and even simultaneously.

In step 406, the processor unit 206 calculates the associated wheel slip separately for each of the four wheels VL, VR, HL and HR. This calculation is carried out for each of the four wheels VL, VR, HL and HR as follows:

s_{RAD}=|v_{REF}−v_{RAD}|/v_{REF},

wherein s_{RAD} is the wheel slip, v_{RAD} is the linear wheel speed and v_{REF} is the vehicle speed.

In step 408, the processor unit 206 performs wheel slip detection separately for each of the four wheels VL, VR, HL and HR. More specifically, the wheel slip s_{RAD} determined for each wheel VL, VR, HL or HR in step 406 is analyzed in respect of reaching or exceeding a slip threshold s_{STABIL}. As long as the wheel slip s_{RAD} determined for a wheel VL, VR, HL or HR is below the slip threshold s_{STABIL}, a control intervention does not (yet) take place. On the contrary, the wheel slip calculation for this wheel VL, VR, HL or HR is continuously repeated (step 408).

However, if the reaching or exceeding of the slip threshold s_{STABIL} is detected for a wheel VL, VR, HL or HR, the processor unit 206 generates one or more control signals for actuating interventions for target slip and, in particular, constant slip control for the corresponding wheel VL, VR, HL or HR in step 410. During this process, the system regulates toward a particular target slip s_{ZIEL}, which is different from zero. The target slip s_{ZIEL} can coincide with the slip threshold s_{STABIL} or can differ therefrom (in particular being greater).

The control signals generated in step 410 for the required actuating interventions are fed to the actuator or actuators of the corresponding wheel VL, VR, HL or HR via the interface 208 (as explained above in the context of the actuating system SYS-1). A new slip calculation is then carried out for the corresponding wheel VL, VR, HL or HR in step 406, and control is continued for as long as reaching or exceeding of the slip threshold s_{STABIL} is detected in step 408.

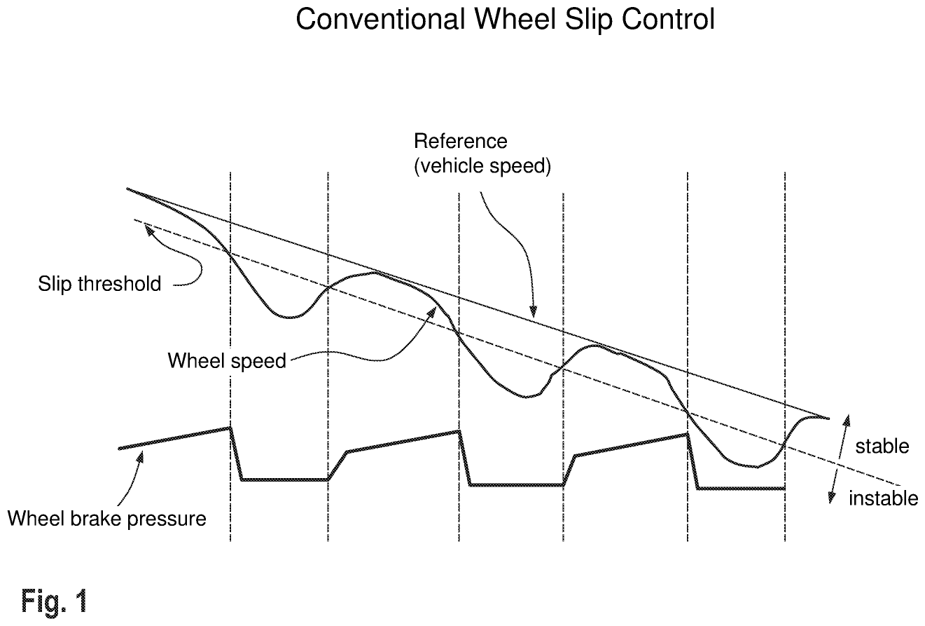

The target slip control strategy explained with reference to FIG. 4, with a constant target slip greater than zero, is graphically illustrated in the diagram shown in FIG. 5 and contrasted with the conventional slip control strategy shown in FIG. 1. It is clearly apparent that, in contrast to conventional slip control, the linear wheel speed of the wheel subject to target slip control deviates continuously from the external reference (vehicle speed). It is likewise apparent that the size of the control interventions (brake pressure fluctuations) at the wheel subject to target slip control is significantly less than in the case of conventional slip control.

As explained with reference to the illustrative embodiments, target slip control is carried out both for the wheels VL, VR on the front axle and for the wheels HL, HR on the rear axle in each case when the slip threshold s_{STABIL} is reached or exceeded. The use of a target slip control strategy for the wheels VL, VR, HL and HR on both axles is possible because the vehicle speed on which control is based does not have to be derived from the angular wheel speeds. On the contrary, the vehicle speed is determined on the basis of a measured variable different from the angular wheel speeds (such as the position signal of a satellite-based positioning system).

The use of a target slip control strategy for the wheels VL, VR, HL and HR on both axles leads to a shorter braking distance. Moreover, the fluctuations of the actuating interventions can be reduced, leading to lower energy consumption and less actuating noise.

1. A device (200; 310) for wheel slip control on a motor vehicle having at least one front axle and at least one rear axle, wherein the front axle is assigned at least one front actuator (SYS-1; 312; 318) for influencing at least one linear front wheel speed, and the rear axle is assigned at least one rear actuator (SYS-1; 314; 316) for influencing at least one linear rear wheel speed, and wherein the device comprises:
at least one interface (202; 204), which is designed to receive the following parameters:
at least one first parameter indicating the at least one linear front wheel speed;
at least one second parameter indicating the at least one linear rear wheel speed; and
at least one third parameter indicating a vehicle speed, wherein the at least one third parameter is different from the at least one first parameter and the at least one second parameter; and
a processor unit (206), which is communicatively coupled to the at least one interface (202; 204) and is designed:
to determine at least one front wheel slip and at least one rear wheel slip on the basis of the at least one first parameter, the at least one second parameter and the at least one third parameter; and
to generate control signals for the at least one front actuator (SYS-1; 312; 318) and/or the at least one rear actuator (SYS-1; 314; 316) as a function of the at least one front wheel slip and the at least one rear wheel slip, in accordance with a target slip which is different from zero.

2. The device as claimed in claim 1, wherein
the at least one first parameter and the at least one second parameter are based on a first measured variable relating to the respective wheel (VL; VR; HL; HR), and the at least one third parameter is based on a second measured variable different from the first measured variable.

3. The device as claimed in any one of the preceding claims, wherein
the at least one interface (204) can be coupled or is coupled to a satellite-based position determination system (320), which is designed to generate the at least one third parameter or a variable on which the at least one third parameter is based.

4. The device as claimed in any one of the preceding claims, wherein
the at least one interface (204) can be coupled or is coupled to a radar-based system (320), which is designed to generate the at least one third parameter or a variable on which the at least one third parameter is based.

5. The device as claimed in any one of the preceding claims, wherein
the at least one interface (204) can be coupled or is coupled to a camera-based system (320), which is designed to generate the at least one third parameter or a variable on which the at least one third parameter is based.

6. The device as claimed in any one of the preceding claims, wherein
the at least one interface (202) is designed to receive both the at least one first parameter and the at least one second parameter in the form of angular wheel speed signals or in the form of linear wheel speeds derived from the angular wheel speed signals.

7. The device as claimed in any one of the preceding claims, wherein
the processor unit (206) is designed to determine a fourth parameter indicating the corresponding slip for a particular wheel (VL; VR; HL; HR) by comparing the corresponding linear wheel speed with the vehicle speed.

8. The device as claimed in claim 7, wherein
the processor unit is designed to determine the fourth parameter for the particular wheel (VL; VR; HL; HR) as follows:
s_{RAD}=|v_{REF}−v_{RAD}|/v_{REF},
wherein s_{RAD} is the fourth parameter, v_{RAD} is the linear wheel speed and v_{REF} is the vehicle speed.

9. The device as claimed in claim 7 or 8, wherein
the control signals for the at least one actuator (SYS-1; 312; 314; 316; 318) assigned to the particular wheel (VL; VR; HL; HR) are determined to the effect that the fourth parameter is regulated toward a target slip s_{ZIEL} different from zero.

10. The device as claimed in any one of the preceding claims, wherein
the control signals for the at least one actuator (SYS-1; 312; 314; 316; 318) assigned to the particular wheel (VL; VR; HL; HR) are determined to the effect that the particular wheel (VL; VR; HL; HR) is alternately decelerated and accelerated.

11. The device as claimed in any one of the preceding claims, wherein
the device (200) is designed as at least one control unit (310).

12. A vehicle brake system (300) comprising:
the device (310) as claimed in any one of the preceding claims;
the at least one front actuator (SYS-1; 312; 318); and
the at least one rear actuator (SYS-1; 314; 316).

13. The vehicle brake system as claimed in claim 12, wherein
the at least one front actuator comprises a front wheel brake (312; 318) and the at least one rear actuator comprises a rear wheel brake (314; 316).

14. A method for wheel slip control on a motor vehicle having at least one front axle and at least one rear axle, wherein the front axle is assigned at least one front actuator (SYS-1; 312; 318) for influencing at least one linear front wheel speed, and the rear axle is assigned at least one rear actuator (SYS-1; 314; 316) for influencing at least one linear rear wheel speed, and wherein the method comprises:
receiving at least one first parameter indicating the at least one linear front wheel speed;
receiving at least one second parameter indicating the at least one linear rear wheel speed;
receiving at least one third parameter indicating a vehicle speed, wherein the at least one third parameter is different from the at least one first parameter and the at least one second parameter;
determining at least one front wheel slip and at least one rear wheel slip on the basis of the at least one first parameter, the at least one second parameter and the at least one third parameter; and
generating control signals for the at least one front actuator (SYS-1; 312; 318) and/or the at least one rear actuator (SYS-1; 314; 316) as a function of the at least one front wheel slip and the at least one rear wheel slip, in accordance with a target slip which is different from zero.

15. A computer program product comprising program code means for carrying out the method as claimed in claim 14 when the latter is carried out on a processor unit.

16. A control unit (310) or system comprising a plurality of control units (310; 320) with the computer program product as claimed in claim 15.
